(19) United States
(12) Patent Application Publication
(10) Pub. No.: US 2026/0131854 A1
(43) Pub. Date: May 14, 2026

(54) STEER-BY-WIRE STEERING SYSTEM

(71) Applicant: TOYOTA JIDOSHA KABUSHIKI KAISHA, Aichi-ken (JP)

(72) Inventors: Takahito ISHINO, Nagakute-shi (JP); Yoshio KUDO, Machida-shi (JP)

(21) Appl. No.: 19/346,568

(22) Filed: Oct. 1, 2025

(30) Foreign Application Priority Data
Nov. 14, 2024 (JP) 2024-199296

(51) Int. Cl. B62D 6/00

(52) U.S. Cl. CPC B62D 6/008

(57) ABSTRACT

A steer-by-wire steering system of a vehicle having a drive simulator includes: an operation device including an operation member to be operated by a driver and a reaction force applying device configured to apply an operation reaction force against an operation of the operation member; a steering device including a steering motor that is an electric motor as a drive source and configured to steer a wheel; and a controller configured to control the steering device and the reaction force applying device. In a simulator mode in which the drive simulator functions, the operation device is used to operate a simulation vehicle to be operated in the drive simulator. In the simulator mode, the controller causes the reaction force applying device to apply the operation reaction force including a vertical-acceleration-dependent component based on a signal relating to vertical acceleration of the simulation vehicle and sent from the drive simulator.

### REFERENCE TO RELATED APPLICATION

This application claims priority from Japanese Patent Application No. 2024-199296 filed on Nov. 14, 2024. The entire content of the priority application is incorporated herein by reference.

### TECHNICAL FIELD

The present disclosure relates to a steer-by-wire steering system of a vehicle.

### BACKGROUND ART

It has been recently considered to mount, on a vehicle, a steer-by-wire type steering system (hereinafter referred to as a “steer-by-wire system” where appropriate), specifically, a system in which an operation member such as a steering wheel and a steering device for steering wheels are mechanically separated. The steer-by-wire system is provided with a reaction force applying device that applies an operation reaction force to an operation of the operation member in order to allow a driver to feel a steering operation.

On the other hand, it has also been considered to enable the driver to enjoy a game using a drive simulator (hereinafter simply referred to as a “simulator” where appropriate) in a vehicle cabin when the vehicle is not actually traveling. In this case, it has also been considered to use the operation member of the steer-by-wire system to operate a vehicle that is to be driven in the simulator (hereinafter referred to as a “simulation vehicle” where appropriate). When the operation member is used to operate the simulation vehicle, it is desirable to apply the operation reaction force as in actual traveling. As for the operation reaction force of the simulator, a technique described in Japanese Patent Application Publication No. 4-232829 is known.

### SUMMARY

In the technique described in the above patent document, in addition to a restoring force for restoring the operation member to a neutral position, vibration based on a vehicle speed and an engine speed of the simulation vehicle is applied as the operation reaction force in order to allow the driver to feel an operation feeling close to actual traveling. There is much room for improvement in a technique of allowing the driver to feel the operational feeling close to actual traveling. The utility of the steer-by-wire system in which the operation member can be used for the operation of the simulation vehicle of the simulator is improved by adding some improvement with respect to application of the operation reaction force. Accordingly, one aspect of the present disclosure relates to a steer-by-wire steering system with high utility.

In one aspect of the present disclosure, a steer-by-wire steering system of a vehicle equipped with a drive simulator includes: an operation device including an operation member to be operated by a driver of the vehicle and a reaction force applying device configured to apply an operation reaction force that is a reaction force against an operation of the operation member; a steering device including a steering motor that is an electric motor as a drive source and configured to steer a wheel; and a controller configured to control the steering device and the reaction force applying device. In a simulator mode in which the drive simulator functions, the operation device is used to operate a simulation vehicle to be operated in the drive simulator. In the simulator mode, the controller causes the reaction force applying device to apply the operation reaction force including a vertical-acceleration-dependent component based on a signal relating to vertical acceleration of the simulation vehicle and sent from the drive simulator.

According to the steering system of the present disclosure, the operation reaction force including the component based on the vertical acceleration generated in the simulation vehicle is applied to the operation member in the simulator mode. The vertical acceleration can indicate a change in a road surface property, i.e., a condition of a road surface on which the simulation vehicle travels. The steering system of the present disclosure enables the driver to feel the change in the road surface property. In simulation in which the simulation vehicle travels on a circuit, for instance, when the simulation vehicle deviates from a course, it is possible to easily give the driver a sense of realism for the deviation.

### Various Forms

The configuration of the present “steer-by-wire steering system” is not limited to particular one, and the steer-by-wire steering system having a general configuration may be adopted. The “drive simulator” operates a “simulation vehicle” that is a vehicle to be operated in a virtual space or a virtual environment. By using the simulator, the driver can enjoy a game or the like when the vehicle is not actually traveling, for example, during charging. In the “simulator mode” in which the simulator functions, steering of the actual wheel by the steering device is not performed.

The “vertical-acceleration-dependent component”, which is one component of the operation reaction force, is a component generated only in the simulator mode. Since the “vertical acceleration” of the simulation vehicle indicates a traveling state of the simulation vehicle, and a condition of a road surface on which the simulation vehicle travels (road surface property), for example, the “vertical-acceleration-dependent component” can be considered to be a component that reflects the traveling state, the road surface condition, etc. By adopting the vertical acceleration component, it is possible to give the driver a sense of realism when the simulation vehicle deviates from the course, for example.

The advantage of using a signal relating to the vertical acceleration in order to give the sense of realism to the driver can be considered as follows, for example. A case in which the simulation vehicle deviates from the course is considered as one example. In this case, the controller may simply receive, from the simulator, a signal indicating that the simulation vehicle has deviated from the course, and the controller may cause the operation member to be vibrated by the operation reaction force based on the signal. However, the vibration is in a single mode. On the other hand, if the signal relating to the vertical acceleration is used, it is possible to apply various modes of vibration to the operation member by changing a vibration period (fluctuation frequency), an amplitude, and the like of the vertical acceleration. That is, by using the signal relating to the vertical acceleration, the period and the amplitude of the vibration generated in the operation member can be dynamically changed easily. For example, in a case where an active suspension system is mounted on a vehicle, it is also possible for the system to apply various vibration movements to the vehicle body itself using the signal.

The vertical-acceleration-dependent component may be determined based on the vertical acceleration whose fluctuation frequency falls within a set range. That is, the vertical acceleration in a certain frequency band may be extracted using, for example, a band-pass filter, and the vertical-acceleration-dependent component may be determined based on the extracted vertical acceleration. Since the fluctuation frequency is based on the vertical acceleration within the set range, it is possible to give an appropriate sense of realism to the driver. The “set range” in this case may be tuned in consideration of case of transmission of the vibration to the driver or may be set based on an unsprung resonance frequency of the vehicle on which the system is mounted. Specifically, the set range may be set to about several Hz to 30 Hz, for example. In addition, it is desirable that the set range be varied based on a traveling speed (hereinafter referred to as a “vehicle speed”) of the simulation vehicle. Specifically, in view of the fact that the fluctuation of the vertical acceleration is caused due to unevenness of the road surface on which the simulation vehicle travels, the period of the fluctuation depends on the vehicle speed of the simulation vehicle. Therefore, the set range is desirably set so as to be higher with an increase in the vehicle speed.

The vertical-acceleration-dependent component is preferably determined to be zero when the vehicle speed of the simulation vehicle is less than a set low vehicle speed and is preferably decreased with an increase in the vehicle speed when the vehicle speed of the simulation vehicle exceeds a set high vehicle speed. This is because, in a low vehicle speed range (e.g., a vehicle speed range of less than 10 km/hr), it is desirable to consider no need to vibrate the operation member and to consider an unnatural feeling due to the operation of the operation member, and on the other hand, in a high vehicle speed range (e.g., a vehicle speed range of more than 80 to 100 km/hr), it is desirable to consider a possibility that the driver feels the vibration of the operation member troublesome. Further, in consideration of a sudden movement of the operation member, it is desirable to limit the vertical-acceleration-dependent component to a set value or less. This set value may be set in consideration of, for example, a magnitude of an impact given to the driver, an unnatural feeling, and the like.

The operation reaction force may include various components. Specifically, the operation reaction force may include, for example, a “steering-force-dependent component” as a central component of the operation reaction force. The “steering force” is a force required to steer a wheel or to maintain a steering amount (steering angle) of the wheel. When the steering device includes a steering rod (rack bar) connecting the right and left wheels, the “steering force” can be considered as a force in the axial direction that acts on the steering rod. Therefore, the steering force may be referred to as an axial force, and the steering-force-dependent component may be referred to as an axial-force-dependent component. As described above, in the simulator mode, the steering force is the steering force for steering the wheel of the simulation vehicle, that is, a simulated steering force.

In the “traveling mode” in which the vehicle actually travels, the steering force is substantially proportional to a torque generated by a steering motor. That is, the steering force is generally proportional to a current supplied to the steering motor. In the traveling mode, therefore, the steering-force-dependent component may be determined based on the current. In the simulator mode, on the other hand, since no current is supplied to the steering motor, the steering-force-dependent component may be determined based on a command from the simulator, specifically, a command relating to the steering force. The command may be a command of a value of the steering-force-dependent component itself or may be a command of any value indicating the steering force.

The “correcting the steering-force-dependent component based on the operation speed of the operation member” may be performed, for example, to compensate for a delay of the command from the simulator. Since the simulator is merely optional equipment of the vehicle, in other words, entertainment equipment, the simulator generally communicates with the controller of the system using a general-purpose communication means such as a CAN (controllable area network or car area network). In this case, the command may suffer from a delay. Since the delay depends on the operation speed of the operation member, the correction is suitable for preventing the delay. Communication in the system is generally performed via a dedicated high-speed communication line. For example, in a case where the controller is divided into a portion for controlling the reaction force applying device and a portion for controlling the steering device, communication between these portions is generally performed via the dedicated high-speed communication line. For example, a signal regarding a current supplied to the steering motor in the traveling mode is arranged not to be delayed.

For example, the correction described above may be performed such that the operation reaction force increases with an increase in the operation speed of the operation member. Such correction is suitable for reducing an influence of the delay in view of the fact that the delay increases with an increase in the operation speed.

The correction described above may be performed, for example, by adding a compensation component determined based on the operation speed of the operation member to a component determined based on the command regarding the steering force and sent from the simulator (hereinafter referred to as a “steering-force-command-dependent component” or simply a “command-dependent component” where appropriate). In this case, as will be described in detail later, the compensation component may be determined in consideration of an operation force of the driver applied to the operation member. Specifically, the compensation component may be determined so as to be decreased with an increase in the operation force. The compensation component may be determined in consideration of the traveling speed of the simulation vehicle to be operated in the simulator. Specifically, the compensation component may be determined so as to be decreased with a decrease in the traveling speed.

### BRIEF DESCRIPTION OF DRAWINGS

The objects, features, advantages, and technical and industrial significance of the present disclosure will be better understood by reading the following detailed description of an embodiment, when considered in connection with the accompanying drawings, in which:

FIG. 1 is a view illustrating an overall configuration of a steering system according to one embodiment;

FIG. 2 is a block diagram illustrating a functional configuration of a controller of the steering system according to the embodiment;

FIG. 3A is a block diagrams illustrating details of functional portions that determine components of an operation reaction force based on a command or a signal from a drive simulator in the functional configuration of the controller;

FIG. 3B is a block diagram illustrating details of functional portions that determine components of the operation reaction force based on the command or the signal from the drive simulator in the functional configuration of the controller;

FIG. 4A is a graph showing a basic compensation component determination map that is referred to when determining the components of the operation reaction force based on a command relating to a steering force from the drive simulator;

FIG. 4B is a graph showing an operation-torque-dependent gain determination map that is referred to when determining the components of the operation reaction force based on a command relating to a steering force from the drive simulator;

FIG. 4C is a graph showing a vehicle-speed-dependent gain determination map that is referred to when determining the components of the operation reaction force based on a command relating to a steering force from the drive simulator;

FIG. 5A is a graph showing an extraction frequency map that is referred to when determining the components of the operation reaction force based on a signal relating to vertical acceleration of a simulation vehicle sent from the drive simulator; and

FIG. 5B is a graph showing a second vehicle-speed-dependent gain determination map that is referred to when determining the components of the operation reaction force based on the signal relating to the vertical acceleration of the simulation vehicle sent from the drive simulator.

### DESCRIPTION

Referring to the drawings, there will be described below in detail a steering system according to one embodiment of the present disclosure. It is to be understood that the present disclosure is not limited to the details of the following embodiment but may be embodied based on the forms described in Various Forms and may be changed and modified based on the knowledge of those skilled in the art.

### 1. Overall Configuration of Steering System

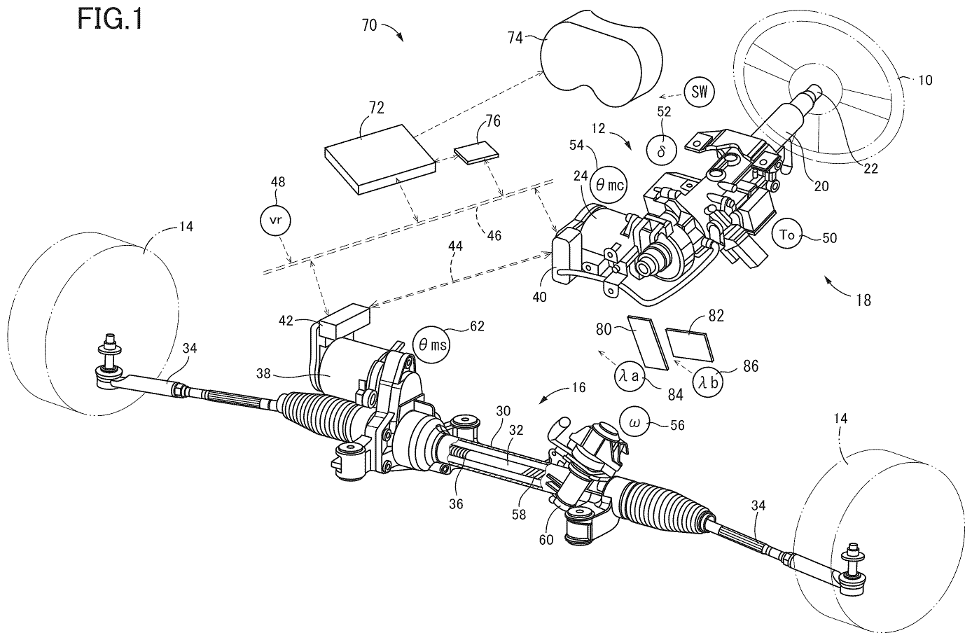

The steering system of the embodiment (hereinafter referred to as “the present steering system” or “the present system” where appropriate) is a steer-by-wire steering system capable of steering wheels without depending on an operation force of a driver applied to an operation member. As illustrated in FIG. 1, the steering system includes a handle (steering wheel) 10 functioning as the operation member, a reaction force actuator 12 functioning as a reaction force applying device to which the handle 10 is connected, and a steering actuator 16 functioning as a steering device to which two wheels 14 (i.e., left and right wheels 14), each functioning as a steerable wheel, are connected to steer the wheels 14 together. The handle 10 is rotated by the driver, and the reaction force actuator 12 receives the rotational operation of the handle 10 and applies, with respect to the handle 10, namely, with respect to the operation of the handle 10, a reaction force (hereinafter referred to as an “operation reaction force” where appropriate) against the operation of the handle 10. It is noted that an operation device 18 of the present steering system is constituted by the handle 10 and the reaction force actuator 12.

The reaction force actuator 12 includes: a steering column 20 supported by a reinforcement of an instrument panel; a steering shaft 22 rotatably held by the steering column 20; and a reaction force motor 24, which is an electric motor, for applying a rotational torque to the steering shaft 22 via a power transmission mechanism. The handle 10 is attached to a rear end portion of the steering shaft 22. Though not explained in detail, the power transmission mechanism includes a worm attached to a motor shaft of the reaction force motor 24 and a worm wheel attached to the steering shaft 22 and meshing the worm. The reaction force motor 24 is a three-phase brushless DC motor and functions as a drive source of the reaction force actuator 12. Owing to the torque generated by the reaction force motor 24, a reaction force torque as the operation reaction force is applied to the handle 10 connected to the steering shaft 22.

The steering actuator 16 includes: a generally cylindrical housing 30 supported by a chassis in a posture extending in the right-left direction; a steering rod (rack bar) 32 supported by the housing 30 so as to be unrotatable and movable in the right-left direction; and a pair of tic rods 34 connected to right and left ends of the steering rod 32 via respective ball joints. One end of each tie rod 34 is connected to the corresponding wheel 14 via the ball joint. Specifically, the tie rod 34 is connected, via the ball joint, to a knuckle arm of a steering knuckle that rotatably holds the wheel 14 and that is held by a suspension arm so as to be turnable.

A threaded groove 36 is formed on the steering rod 32. Though not illustrated, a nut holding bearing balls and threadedly engaging the threaded groove 36 is held in the housing 30 such that the nut is rotatable and immovable in the right-left direction. That is, a ball screw mechanism is constituted by the steering rod 32 and the nut. A steering motor 38, which is an electric motor, is attached to the housing 30. The steering motor 38 rotates the nut via a power transmission mechanism. Though not illustrated, the power transmission mechanism includes a pulley attached to the motor shaft of the steering motor 38 and a timing belt looped over the pulley and the outer circumference of the nut. The steering motor 38 is a three-phase brushless DC motor and functions as a drive source of the steering actuator 16. When the steering motor 38 is rotated, the steering rod 32 is moved rightward and leftward, so that the right and left wheels 14 are steered together.

The reaction force actuator 12 is controlled by a reaction force electronic control unit (hereinafter referred to as a “reaction force ECU” where appropriate) 40 attached to the reaction force motor 24. The reaction force ECU 40 is constituted by a computer including a CPU, a ROM, a RAM, etc., and an inverter that is a driver (drive circuit) of the reaction force motor 24. The reaction force ECU 40 is powered by a battery. Similarly, the steering actuator 16 is controlled by a steering electronic control unit (hereinafter referred to as a “steering ECU” where appropriate) 42 attached to the steering motor 38. The steering ECU 42 is constituted by a computer including a CPU, a ROM, a RAM, etc., and an inverter that is a driver (drive circuit) of the steering motor 38. The steering ECU 42 is powered by the battery.

The reaction force ECU 40 and the steering ECU 42 cooperate with each other to constitute one controller of the present steering system. The reaction force ECU 40 and the steering ECU 42 are connected via a dedicated high-speed communication line 44. Both the reaction force ECU 40 and the steering ECU 42 are connected to a CAN (car area network or controllable area network) 46 of the vehicle. A vehicle speed sensor 48 for detecting an actual vehicle speed vr, which is an actual traveling speed of the vehicle, is also connected to the CAN 46.

The reaction force actuator 12 includes, as a constituent element relating to the control, an operation torque sensor 50. Though not explained in detail, the operation torque sensor 50 detects a torsional amount of the steering shaft 22 to thereby detect an operation torque To, which is the operation force applied to the handle 10 by the driver. Further, the reaction force actuator 12 includes an operation angle sensor 52 configured to detect a rotational angle of the steering shaft 22 to thereby detect an operation angle δ of the handle 10 and a reaction force motor rotational angle sensor 54 configured to detect a rotational angle (rotational phase) θmc of the reaction force motor 24 for phase switching.

A steering angle of the wheels 14 and the positon of the steering rod 32 in the right-left direction have a specific relationship. Thus, the steering actuator 16 includes a steering angle sensor 56 configured to detect the position of the steering rod 32 for detecting the steering angle of the wheels 14. Briefly, a rack 58 is formed on the steering rod 32, and a pinion shaft 60 engaging the rack 58 is held by the housing 30. Though a turning angle (toc angle) of the wheel 14 may be considered as the steering angle, the rotational angle of the pinion shaft 60 detected by the steering angle sensor 56 is treated as the steering angle ω of the wheel 14 in the present system. The steering actuator 16 includes a steering motor rotational angle sensor 62 for detecting a rotational angle (rotational phase) θms of the steering motor 38 for phase switching.

A vehicle on which the present system is installed is equipped with a drive simulator (hereinafter simply referred to as “simulator”) 70. The simulator 70 is a device that causes a simulation vehicle, which is a virtual operation target, to travel in a virtual environment (virtual space) and realizes, as an image, a change in scenery (environmental component) or the like viewed from the simulation vehicle. When the vehicle is stopped during charging of the vehicle or the like, for example, the driver of the vehicle can enjoy a game or the like by the simulator 70.

The simulator 70 includes a simulator body 72 mainly constituted by a computer, a goggle-type head mount display (hereinafter simply referred to as a “display” where appropriate) 74 that enables the driver to view an image from the viewpoint of the simulation vehicle, and a simulation permission determiner 76 that determines whether or not the simulator 70 is operable. Incidentally, though the present simulator 70 employs the head mount display 74 as the image realizing means, it is possible to employ various means such as a head-up display in which an image is projected on a windshield of the vehicle, a large display disposed in front of the vehicle, and a screen disposed in front of the vehicle and a projector for projecting an image on the screen.

For operating the simulation vehicle in simulation, the present system, specifically, the operation device 18 of the present system, is used. Therefore, the simulator body 72 and the simulation permission determiner 76 are connected to the CAN 46, and communication between the simulator 70 and the present system is performed via the CAN 46. Since an accelerator pedal 80 and a brake pedal 82 of the vehicle are also used to operate the simulation vehicle, there are connected, to the CAN 46, an accelerator operation amount sensor 84 for detecting an accelerator operation amount λa, which is an operation amount of the accelerator pedal 80, and a brake operation amount sensor 86 for detecting a brake operation amount λb, which is an operation amount of the brake pedal 82.

### 2. Functions of Controller

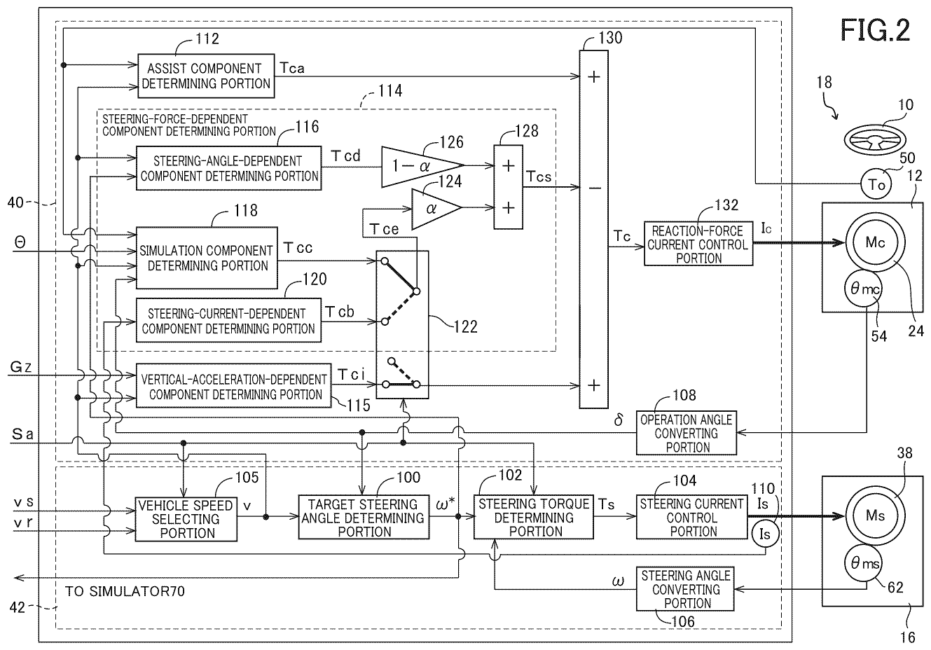

The controller of the steering system including the reaction force ECU 40 and the steering ECU 42 has a functional configuration shown in a functional block diagram of FIG. 2. The computer executes a predetermined program to effectuate the functional configuration. Most of signals input to or output from the constituent elements (functional portions) shown in the drawing are signals indicating values of a torque, components thereof, a steering angle, an operation angle, and the like. For avoiding redundancy of the description, it is simply expressed in the following description that the torque, the components thereof, the steering angle, the operation angle, and the like are input to or output from the constituent elements. For case of understanding, there will be described, in order, functions related to a steering control by the steering ECU 42 in a traveling mode in which the vehicle is actually traveling, functions related to a reaction force control by the reaction force ECU 40 in the traveling mode, and a reaction force control by the reaction force ECU 40 in a simulator mode in which drive simulation by the simulator 70 is executed.

### (a) Steering Control in Traveling Mode

The steering control is a control of the steering angle ω of the wheels 14 steered by the steering actuator 16. The steering ECU 42, which functions as a steering control section, includes a target steering angle determining portion 100, a steering torque determining portion 102, and a steering current control portion 104. In the reaction force control and the steering control, the vehicle speed v, which is the traveling speed of the vehicle, is employed. The employed vehicle speed v differs between the traveling mode and the simulator mode. Specifically, in the traveling mode, the employed vehicle speed is an actual vehicle speed vr which is an actual traveling speed of the vehicle, and in the simulator mode, the employed vehicle speed is a simulator vehicle speed vs which is a traveling speed of the simulation vehicle in the simulator 70. Therefore, the steering ECU 42 includes a vehicle speed selecting portion 105 to selectively employ, as the vehicle speed v, one of the actual vehicle speed vr detected by the vehicle speed sensor 48 and the simulator vehicle speed vs transmitted from the simulator body 72. The vehicle speed selecting portion 105 selects either the actual vehicle speed vr or the simulator vehicle speed vs based on a simulation permission signal Sa transmitted from the simulation permission determiner 76. Specifically, in the traveling mode, simulation is prohibited and the actual vehicle speed vr is selected. In the simulation mode, the simulation is permitted and the simulator vehicle speed vs is selected.

In the control of the present steering system, the steering angle ω is used as the steering amount of the wheels 14. The steering angle ω is not a value detected by the steering angle sensor 56, but a value converted based on the steering motor rotational angle θms detected by the steering motor rotational angle sensor 62. Therefore, the steering ECU 42 includes a steering angle converting portion 106 for converting the steering motor rotational angle θms detected by the steering motor rotational angle sensor 62 to the steering angle ω. The steering angle ω and a cumulative amount of the steering motor rotational angle θms have a relationship to satisfy a predetermined speed reduction ratio. Thus, the steering angle converting portion 106 performs the conversion based on the speed reduction ratio.

The target steering angle determining portion 100 determines a target steering angle ω*, which is a control target of the steering angle ω, based on the operation angle δ converted by an operation angle converting portion 108 of the reaction force ECU 40 described later. In the present steering system, a steering gear ratio γ, that is, a ratio of the steering angle ω with respect to the operation angle δ, is changed depending on the vehicle speed v. The target steering angle determining portion 100 determines the target steering angle ω* based on the operation angle δ and the vehicle speed v referring to stored map data. Incidentally, the technique of changing the steering gear ratio γ is known, a description of which is dispensed with. Since the target steering angle ω* is also used as a target steering angle of the simulation vehicle in simulation, the target steering angle ω* is transmitted to the simulator 70, specifically, the simulator body 72, via the CAN 46.

The steering torque determining portion 102 is a functional portion for determining a steering torque Ts required to steer the wheels 14. The steering torque Ts may be considered as a torque to be generated by the steering motor 38, for example. Specifically, the steering torque determining portion 102 identifies a steering angle deviation Δω, which is a deviation of the steering angle ω with respect to the target steering angle ω*, based on the target steering angle ω* and the actual steering angle ω at the present time converted by the steering angle converting portion 106. According to a PID feedback control law, the steering torque determining portion 102 determines the steering torque Ts to be generated, based on the steering angle deviation Δω. The determination technique according to the PID feedback control law is known, a detailed description of which is dispensed with.

The steering current control portion 104 includes an inverter that is a drive circuit (driver) for the steering motor 38. Based on the determined steering torque Ts, the steering current control portion 104 determines a steering current Is, which is a current to be supplied to the steering motor 38, and supplies the steering current Is to the steering motor 38 from the inverter. The steering ECU 42 includes a current sensor 110 for detecting the steering current Is that is being actually supplied.

In the simulator mode, it is not necessary to steer the wheels 14 of the vehicle. Thus, the steering torque determining portion 102 does not determine the steering torque Ts, and a signal as to the steering torque Ts is not transmitted to the steering current control portion 104. The determination of the steering torque Ts and the execution/non-execution of the transmission of the signal are determined based on the simulation permission signal Sa described above.

### (b) Reaction Force Control in Traveling Mode

The reaction force ECU 40, which is a reaction force control section, controls the reaction force torque Tc to be applied to the handle 10 by the reaction force actuator 12, which is a reaction force applying device. The reaction force ECU 40 includes an assist component determining portion 112 for determining an assist component Tca, a steering-force-dependent component determining portion 114 for determining a steering-force-dependent component Tcs, and a vertical-acceleration-dependent component determining portion 115 for determining a vertical-acceleration-dependent component Tci that will be described in detail in a reaction force control in the simulator mode. Each of the assist component Tea, the steering-force-dependent component Tcs, and the vertical-acceleration-dependent component Tci is a component of the reaction force torque Tc.

The steering-force-dependent component Tcs is determined by adjustment between a steering-angle-dependent component Ted and an estimated actual steering-force-dependent component Tce. The estimated actual steering-force-dependent component Tce is determined to be a steering-current-dependent component Teb in the traveling mode and is determined to be a simulation component Tcc (which will be described in detail later) in the simulator mode. Since the steering-force-dependent component Tcs includes these components, the steering-force-dependent component determining portion 114 includes a steering-angle-dependent component determining portion 116, a simulation component determining portion 118, a steering-current-dependent component determining portion 120, a part of a component switching portion 122, weighting portions 124, 126, and an adder 128.

In the control of the steering system, an operation angle δ is utilized as an operation amount of the handle 10. Thus, like the steering ECU 42, the reaction force ECU 40 includes the operation angle converting portion 108 configured to convert the reaction force motor rotational angle θmc detected by the reaction force motor rotational angle sensor 54 to the operation angle δ. The operation angle δ and a cumulative amount of the reaction force motor rotational angle θmc have a relationship to satisfy a predetermined speed reduction ratio. Thus, the operation angle converting portion 108 performs the conversion based on the speed reduction ratio.

Determination of the components of the reaction force torque Tc relating to the traveling mode will be described in order. The assist component Tca is a component similar to an assist force in what is called power steering. The assist component determining portion 112 determines the assist component Tea based on the operation torque To detected by the operation torque sensor 50 and the vehicle speed v. In short, the assist component Tea is determined to be a greater value with an increase in the operation torque To. Further, the assist component Tca is determined to be a smaller value when the vehicle speed v is high for giving the vehicle driver a heavy operation feeling with respect to the operation of the handle 10 and is determined to be a greater value when the vehicle speed v is low for giving the vehicle driver a light operation feeling with respect to the operation of the handle 10. The direction of the assist component Tca is the same as the operation direction of the handle 10, that is, the steering operation direction.

The steering-force-dependent component Tcs is considered as a main component of the reaction force torque Tc, and roughly speaking, it is a component for causing the driver to feel a steering force, which is a force required to steer the wheels 14. The steering-force-dependent component Tcs may also be considered as an axial-force-dependent component, that is, a component based on a force (axial force) that acts on the steering rod 32 of the steering actuator 16 in the axial direction of the steering rod 32. The steering-force-dependent component Tcs is generally a component in a direction opposite to the steering operation direction.

The steering-angle-dependent component Ted, which is one component of the steering-force-dependent component Tcs, is considered as an ideal steering force determined based on a model of the vehicle, that is, a force substantially corresponding to a self-aligning torque. In other words, the steering-angle-dependent component Ted may be considered as a steering force on which road surface information, such as unevenness of the road surface that does not affect the behavior of the vehicle in the lateral direction and steps that affect the behavior of the vehicle in the lateral direction, is not reflected. Though not described in detail, the steering-angle-dependent component determining portion 116 determines the steering-angle-dependent component Tcd according to a predetermined map based on the vehicle speed v and the target steering angle ω* determined by the target steering angle determining portion 100 of the steering ECU 42. The steering-angle-dependent component Ted is determined to be a greater value with an increase in the target steering angle ω* and is determined to be a greater value with an increase in the vehicle speed v.

As described above, the simulation component Tec determined by the simulation component determining portion 118 is the estimated actual steering-force-dependent component Tce in the simulator mode. Thus, the simulation component determining portion 118 and the simulation component Tec will be described later. Switching between the simulation component Tec and the steering-current-dependent component Teb is performed by the component switching portion 122. This switching is performed based on the simulation permission signal Sa described above.

Unlike the steering-angle-dependent component Ted, the steering-current-dependent component Tcb, which is the estimated actual steering-force-dependent component Tce in the traveling mode, is a component that reflects the influence of the road surface information described above. In other words, the steering-current-dependent component Teb is, for example, a component that allows the vehicle driver to widely feel also a force acting on the wheels 14 from the road surface. Simply speaking, the steering-current-dependent component determining portion 120 determines the steering-current-dependent component Teb by multiplying the actual steering current Is detected by the current sensor 110 by a set current-steering force conversion gain Kb.

The adjustment between the steering-angle-dependent component Ted and the estimated actual steering-force-dependent component Tce is performed as follows. The estimated steering-angle-dependent component Tce is multiplied by a weighting coefficient α (0<α<1) by the weighting portion 124, and the steering-angle-dependent component Ted is multiplied by a value obtained by dividing the weighting coefficient α by 1 by the weighting portion 126. The products are added by the adder 128 to determine the steering-force-dependent component Tcs. Although a detailed description is omitted, the weighting coefficient α may be set so as to be fixed or may be set so as to change depending on various factors such as the vehicle speed v, the condition of the road surface on which the vehicle travels, and the traveling state of the vehicle.

The assist component Tca determined by the assist component determining portion 112 and the steering-force-dependent component Tcs determined by the steering-force-dependent component determining portion 114 are composited by a compositing portion 130 to determine the reaction torque Tc. The determined reaction torque Tc is input to a reaction-force current control portion 132. The reaction-force current control portion 132 includes an inverter that is a drive circuit (driver) of the reaction force motor 24. The reaction-force current control portion 132 determines a reaction force current Ic, which is a current to be supplied to the reaction force motor 24, based on the reaction force torque Tc, and supplies the reaction force current Ic from the inverter to the reaction force motor 24.

### (c) Reaction Force Control in Simulator Mode

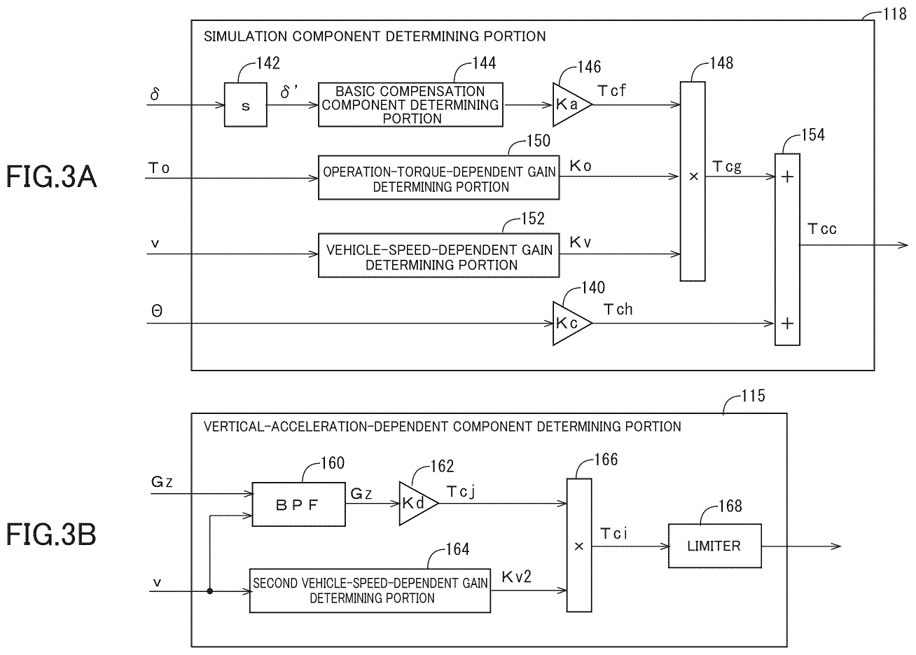

As described above, in the simulator mode, the simulation component Tcc is determined as the estimated actual steering-force-dependent component Tce instead of the steering-current-dependent component Tcb described above. In the simulator mode, the vertical-acceleration-dependent component Tci is added as one component of the reaction torque Tc. Except for these points, the reaction force control in the simulator mode is the same as the reaction force control in the traveling mode. There will be hereinafter described with reference to block diagrams of FIGS. 3A and 3B i) the simulation component Tec and the function of the simulation component determining portion 118 for determining the simulation component Tcc and ii) the vertical-acceleration-dependent component Tci and the function of the vertical-acceleration-dependent component determining portion 115 for determining the vertical-acceleration-dependent component Tci.

### i) Simulation Component and Simulation Component Determining Portion

As shown in the block diagram of FIG. 3A, a simulator command value Θ transmitted from the simulator body 72 via the CAN 46 is input to the simulation component determining portion 118. The simulator command value Θ indicates the estimated actual stecring-force-dependent component Tce to be generated by the simulator 70. By multiplying the simulator command value Θ by a conversion gain Kc by a conversion gain multiplier 14, a simulator command component Tch is determined. Incidentally, if the simulator command value Θ is the same in unit as the reaction torque Te and the component thereof, in other words, if the simulator command component Tch is directly input from the simulator body 72, it is not necessary to provide the conversion gain multiplier 140.

As described above, since the simulator command value Θ is transmitted from the simulator body 72 by communication. Thus, there may be generated a delay, namely, a phase dely. In order to eliminate or reduce the delay, the simulation component determining portion 118 performs correction processing utilizing a compensation component Teg as described below.

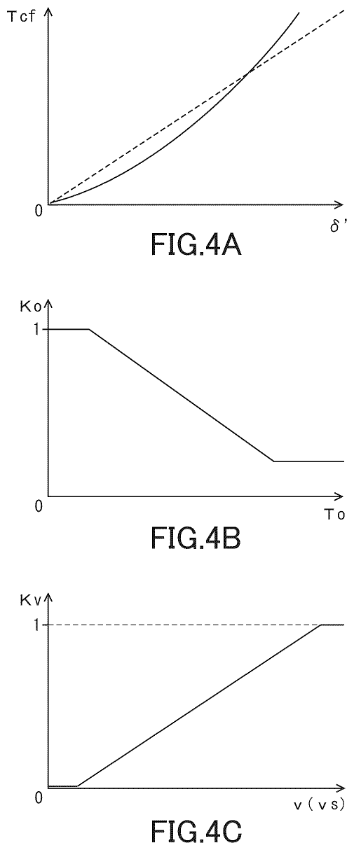

The operation angle & converted by the operation angle converting portion 108 is input to the simulation component determining portion 118. The simulation component determining portion 118 has a differentiator 142. The differentiator 142 calculates an operation speed δ′(=dδ/dt) of the handle 10 that is the operation member. Referring to a basic compensation component determination map shown by a graph of FIG. 4A, a basic compensation component determining portion 144 determines a basic compensation component Tef based on the operation speed δ′. The basic compensation component determination map is set such that the basic compensation component Tef increases with an increase in the operation speed δ′ in view of the fact that a delay increases with an increase in the operation speed δ′.

The basic compensation component determination map may be set such that the basic compensation component Tcf changes linearly with respect to the operation speed δ′, as indicated by a broken line in the graph. However, if the basic compensation component Tcf increases, a damping component of the reaction force torque Tc increases, so that clarity of the operation feeling of the handle 10 is impaired, resulting in a reduction in the realistic feeling of the simulation. Therefore, as indicated by a solid line in the graph, it is possible to employ a nonlinear basic compensation component determination map in which the basic compensation component Tef is small in a region where a delay is relatively small with respect to the operation speed δ′, that is, in a region where the operation speed δ′ is low. If the basic compensation component Tef linearly changes with respect to the operation speed δ′, the basic compensation component Tcf may be determined by a fixedly set gain without using the map.

In the simulation component determining portion 118, the basic compensation component Tcf determined by the basic compensation component determining portion 144 is multiplied by a contribution degree change gain Ka in a contribution degree change gain multiplier 146 to determine a final basic compensation component Tcf. The contribution degree change gain Ka changes a contribution degree of the basic compensation component Tef in the simulation component Tcc. For example, the magnitude of the basic compensation component Tef can be changed in accordance with the vehicle speed vs of the simulation vehicle, the road surface on which the simulation vehicle travels, the traveling state of the simulation vehicle, and the like, in the simulation. However, if the function of changing the contribution degree is taken into consideration in the basic compensation component determination map, it is not necessary to provide the contribution degree change gain multiplier 146.

The simulation component determining portion 118 has a correcting portion 148. The correcting portion 148 determines the compensation component Teg by multiplying the determined basic compensation component Tef by an operation-torque-dependent gain Ko and a vehicle-speed-dependent gain Kv.

The operation-torque-dependent gain Ko is set in consideration of another influence caused by an increase in the compensation component Teg. Specifically, when the compensation component Teg increases, the road surface information such as a decrease in the operation reaction force at a tire grip limit of the simulation vehicle is not transmitted to the driver. The operation-torque-dependent gain Ko takes this into consideration. An operation-torque-dependent gain determining portion 150 determines the operation-torque-dependent gain Ko based on the operation torque To detected by the operation torque sensor 50 according to an operation-torque-dependent gain determination map shown by a graph of FIG. 4B. According to the thus determined operation-torque-dependent gain Ko, the compensation component Teg is made small in a high operation torque range in which high turning lateral acceleration is generated. In this respect, information on the turning lateral acceleration generated in the simulation vehicle may be input from the simulator body 72 to the reaction force ECU 40, and the operation-torque-dependent gain determining portion 150 may determine the operation-torque-dependent gain Ko based on the lateral acceleration instead of the operation torque To. In this case, when a communication speed of the turning lateral acceleration information is low, the operation-torque-dependent gain Ko may be determined based on a differential value of the lateral acceleration. In this case, the operation-torque-dependent gain determining portion 150 is preferably referred to as a lateral-acceleration-dependent gain determining portion, and the operation-torque-dependent gain Ko is preferably referred to as a lateral-acceleration-dependent gain.

The vehicle-speed-dependent gain Kv is a gain for adjusting the compensation component Teg in accordance with the vehicle speed v, specifically, a simulator vehicle speed vs. In general vehicle characteristics, a response of a self-aligning torque that acts on the wheels with respect to the operation of the handle 10 is delayed in a high-speed range in which the vehicle speed v is high. In consideration of this, a vehicle-speed-dependent gain determining portion 152 determines the vehicle-speed-dependent gain Kv based on the vehicle speed v according to a vehicle-speed-dependent gain determination map shown by a graph of FIG. 4C. According to the thus determined vehicle-speed-dependent gain Kv, the compensation component Teg is increased with an increase in the vehicle speed v.

The compensation component Teg determined through the correcting portion 148 is added to the simulator command component Tch by an adder 154. In other words, the simulator command component Tch is corrected by the compensation component Teg. As a result, the simulation component Tec is determined.

The reaction force control in the simulator mode will be briefly summarized in relation to the steering-force-dependent component Tcs. In the traveling mode, the reaction torque Tc as the operation reaction force is determined based on the steering-force-dependent component Tcs that is determined based on the current Is supplied to the steering motor 38. In the simulator mode, the reaction torque Tc as the operation reaction force is determined based on a component obtained by correcting the simulator command component Tch based on the operation speed δ′ of the handle 10 as the operation member. The simulator command component Tch is a command-dependent component (steering-force-command-dependent component) based on the simulator command value Θ, which is a command from the simulator 70. This correction is performed to compensate for a delay in the command from the simulator 70. Specifically, the correction is performed such that the reaction torque Te increases with an increase in the operation speed δ′ of the handle 10. More specifically, the correction is performed by adding the compensation component Tcg determined based on the operation speed δ′ of the handle 10 to the simulator command component Tch. The compensation component Teg is determined in consideration of the operation torque To, which is the operation force applied to the handle 10, and in consideration of the simulator vehicle speed vs, which is the traveling speed of the simulation vehicle to be operated in the simulator 70.

### ii) Vertical-Acceleration-Dependent Component and Vertical-Acceleration-Dependent Component Determining Portion

As shown in the block diagram of FIG. 3B, there is input, to the vertical-acceleration-dependent component determining portion 115, a signal as to vertical acceleration Gz of the simulation vehicle transmitted from the simulator body 72 via the CAN 46. The vertical acceleration Gz varies periodically and is passed through a band-pass filter 160 to extract only a component of a fluctuation frequency f (Gz) in a set range.

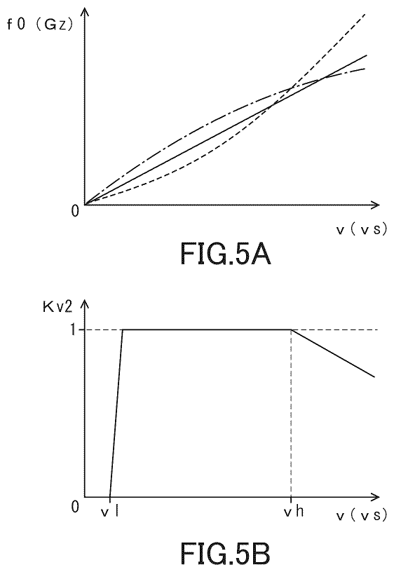

The band-pass filter 160 is configured to change a setting range of the fluctuation frequency f (Gz) of the component to be extracted, that is, a set frequency band, depending on the vehicle speed v (simulator vehicle speed vs). Specifically, the vertical acceleration Gz of the fluctuation frequency f (Gz) in the set frequency band is extracted with reference to an extraction frequency map shown by a graph of FIG. 5A. In the graph, the horizontal axis represents the vehicle speed v, and the vertical axis represents a frequency median f0 (Gz), which is the fluctuation frequency f (Gz) that is a median of the set frequency band. The band-pass filter 160 extracts the vertical acceleration Gz in the frequency band of a set width centered on the fluctuation frequency f (Gz). The solid line in the graph represents the frequency median f0 (Gz) in the extraction frequency map employed by the band-pass filter 160. The band-pass filter 160 employs an extraction frequency map in which the frequency median f0 (Gz) increases linearly with an increase in the vehicle speed v. Instead of such an extraction frequency map, there may be employed an extraction frequency map in which the frequency median value f0 (Gz) changes non-linearly with respect to the vehicle speed v as indicated by the broken line or the one-dot chain line in the graph. Specifically, the set frequency band, that is, the set range of the fluctuation frequency f (Gz), may be set such that the frequency median f0 (Gz) is several Hz to 30 Hz when the vehicle speed v is 50 km/hr, for example.

The vertical acceleration Gz extracted as described above is multiplied by a conversion gain Kd in a conversion gain multiplier 162 to determine a basic vertical-acceleration-dependent component Tcj. Simply speaking, the conversion gain Kd is a gain for changing the unit of the vertical acceleration Gz to the basic vertical-acceleration-dependent component Tcj.

On the other hand, the vertical-acceleration-dependent determination portion 115 includes a second vehicle-speed-dependent gain determining portion 164 that determines a second vehicle-speed-dependent gain Kv2. The second vehicle-speed-dependent gain Kv2 is a gain for changing the basic vertical-acceleration-dependent component Tej in accordance with the vehicle speed v. The second vehicle-speed-dependent gain determining portion 164 determines the second vehicle-speed-dependent gain Kv2 based on the vehicle speed v (simulator vehicle speed vs) with reference to a second vehicle-speed-dependent gain determination map shown by a graph of FIG. 5B. According to the second vehicle-speed-dependent gain determination map, the second vehicle-speed-dependent gain Kv2 is determined to be 1 in a middle vehicle speed range, is determined to be 0 in a low vehicle speed range in which the vehicle speed v is less than a low vehicle speed v1, and is determined so as to decrease from 1 with an increase in the vehicle speed v in a high vehicle speed range in which the vehicle speed exceeds a high vehicle speed vh. The low vehicle speed v1 and the high vehicle speed vh may be freely set in accordance with the characteristics of the required reaction torque Tc. In the second vehicle-speed-dependent gain determination map, for example, the low vehicle speed v1 is set to 10 km/hr, and the high vehicle speed vh is set to 90 km/hr. By changing the second vehicle-speed-dependent gain determination map, it is possible to allow the second vehicle-speed-dependent gain Kv2 to have the conversion function of the conversion gain Kd. In this case, the conversion gain Kd and the conversion gain multiplier 162 can be omitted.

The basic vertical-acceleration-dependent component Tej determined as described above is multiplied by the second vehicle-speed-dependent gain Kv2 in a multiplier 166, whereby the vertical-acceleration-dependent component Tci is determined. By the second vehicle-speed-dependent gain Kv2, the vertical-acceleration-dependent component Tci is determined to be 0 in the low vehicle speed range, and is decreased with an increase in the vehicle speed v in the high vehicle speed range.

The vertical-acceleration-dependent component determining portion 115 is provided with a limiter 168, and the determined vertical-acceleration-dependent component Tci is passed through the limiter 168. The limiter 168 has a function of limiting the vertical-acceleration-dependent component Tci to a set value or less. Specifically, the vertical acceleration Gz vibrates so as to take positive and negative values, and the vertical-acceleration-dependent component Tci also vibrates so as to take positive and negative values. Therefore, the limiter 168 limits an absolute value of the vertical-acceleration-dependent component Tci to the set value or less.

As shown in the block diagram of FIG. 2, the vertical-acceleration-dependent component Tci is input to the compositing portion 130 via the component switching portion 122. The component switching portion 122 switches generation/non-generation of the vertical-acceleration-dependent component Tci so as to generate the vertical-acceleration-dependent component Tci in the simulator mode and so as not to generate the vertical-acceleration-dependent component Tci in the traveling mode, based on the simulation permission signal Sa described above. That is, the reaction torque Tc is determined so as to include the vertical-acceleration-dependent component Tci only in the simulator mode.

To briefly summarize the reaction force control in the simulator mode as to the vertical-acceleration-dependent component Tci, in the simulator mode, the operation torque Tc including the vertical-acceleration-dependent component Tci based on the signal related to the vertical acceleration Gz of the simulation vehicle is applied to the handle 10. Since the vertical acceleration Gz varies substantially periodically in accordance with the property (the condition) of the road surface on which the simulation vehicle travels, the vertical-acceleration-dependent component Tci also varies substantially periodically. As a result, the handle 10 is vibrated in accordance with the variation. For example, when the simulation vehicle deviates from a course in a circuit, the amplitude of the vibration is relatively large, and the driver experiences an appropriate realistic feeling.

In the present system, the vertical-acceleration-dependent component Tci is determined based on the vertical acceleration Gz whose fluctuation frequency f (Gz) falls within the set range, and the set range is set so as to be higher with an increase in the simulator vehicle speed vs, which is the vehicle speed v of the simulation vehicle. In the present system, when the simulator vehicle speed vs is less than the low vehicle speed v1, the vertical-acceleration-dependent component Tci is set to be equal to 0. When the simulator vehicle speed vs exceeds the high vehicle speed vh, the vertical-acceleration-dependent component Tci is decreased with an increase in the simulator vehicle speed vs. Further, the vertical-acceleration-dependent component Tci is limited to the set value or less.

What is claimed is:

1. A steer-by-wire steering system of a vehicle equipped with a drive simulator, comprising:
an operation device including an operation member to be operated by a driver of the vehicle and a reaction force applying device configured to apply an operation reaction force that is a reaction force against an operation of the operation member;
a steering device including a steering motor that is an electric motor as a drive source and configured to steer a wheel; and
a controller configured to control the steering device and the reaction force applying device,
wherein, in a simulator mode in which the drive simulator functions, the operation device is used to operate a simulation vehicle to be operated in the drive simulator, and
wherein, in the simulator mode, the controller causes the reaction force applying device to apply the operation reaction force including a vertical-acceleration-dependent component based on a signal relating to vertical acceleration of the simulation vehicle and sent from the drive simulator.

2. The steer-by-wire steering system according to claim 1, wherein the controller is configured to determine the vertical-acceleration-dependent component based on the vertical acceleration whose fluctuation frequency falls within a set range.

3. The steer-by-wire steering system according to claim 2, wherein the controller is configured to set the set range so as to be higher with an increase in a traveling speed of the simulation vehicle.

4. The steer-by-wire steering system according to claim 1, wherein the controller determines the vertical-acceleration-dependent component to be zero when a traveling speed of the simulation vehicle is less than a set low traveling speed.

5. The steer-by-wire steering system according to claim 1, wherein the controller reduces the vertical-acceleration-dependent component in accordance with an increase in a traveling speed of the simulation vehicle when the traveling speed exceeds a set high traveling speed.

6. The steer-by-wire steering system according to claim 1, wherein the controller is configured to limit the vertical-acceleration-dependent component to a set value or less.

7. The steer-by-wire steering system according to claim 1, wherein the controller is configured to: cause the reaction force applying device to apply the operation reaction force including a steering-force-dependent component based on a steering force that is a force for steering the wheel; and determine, in the simulator mode, the steering-force-dependent component based on a command regarding the steering force and sent from the drive simulator.

8. The steer-by-wire steering system according to claim 7, wherein the controller is configured to determine, in a traveling mode in which the vehicle actually travels, the steering-force-dependent component based on a current supplied to the steering motor.

9. The steer-by-wire steering system according to claim 7, wherein, in the simulator mode, the controller determines the steering-force-dependent component by correcting, based on an operation speed of the operation member, a component determined based on the command regarding the steering force and sent from the drive simulator.
